(19) United States
(12) Patent Application Publication
(10) Pub. No.: US 2009/0167143 A1
(43) Pub. Date: Jul. 2, 2009

(54) CATHODE RAY TUBE INCLUDING ELECTRON GUN

(75) Inventor: Sungho Jo, Gumi-city (KR)

Correspondence Address: OCCHIUTI ROHLICEK & TSAO, LLP, 10 FAWCETT STREET, CAMBRIDGE, MA, 02138, US

(73) Assignee: LG. PHILIPS DISPLAYS KOREA CO., LTD., Gumi-city (KR)

(21) Appl. No.: 12/175,729

(22) Filed: Jul. 18, 2008

(30) Foreign Application Priority Data
Dec. 28, 2007 (KR) 10-2007-0139780

(51) Int. Cl. H01J 29/50

(52) U.S. Cl. 313/414

(57) ABSTRACT

A cathode ray tube including an electron gun is disclosed. The cathode ray tube includes a panel, a funnel fused to a rear end of the panel, an electron gun which is inserted into the funnel and includes a focus electrode for focusing electron beams emitted from a cathode, and a field controller positioned inside or on a surface of the focus electrode. The field controller surrounds a portion or the entire of an outside electron beam among the aligned electron beams.

### CROSS-REFERENCE TO RELATED APPLICATIONS

This application claims the benefit of Korean Patent Application No. 10-2007-0139780 filed on Dec. 28, 2007, which is hereby incorporated by reference.

### BACKGROUND

1. Field

An exemplary embodiment relates to a cathode ray tube, and more particularly, to a cathode ray tube including an electron gun.

2. Description of the Background Art

FIG. 1 shows an electron beam affected by a vertical deflection magnetic field. As shown in FIG. 1, a general cathode ray tube generates a vertical deflection magnetic field to thereby control a path of electron beams. However, because the vertical deflection magnetic field is generated in a barrel form, vertical convergence characteristics of a green, blue or red electron beam worsens as the green, blue or red electron beam is far away from the center of a display surface of the cathode ray tube. In other words, because a vertical convergence variation VCR increases, the image quality of the cathode ray tube is reduced.

FIG. 2 shows a CY coil used to improve the vertical convergence characteristics. As described above, the +CY coil is added to the cathode ray tube to improve the vertical convergence characteristics. As shown in FIG. 2, the CY coil produces a compensation magnetic field compensating for the barrel-shaped vertical deflection magnetic field to thereby reduce the vertical convergence variation. However, the addition of the CY coil causes an increase in the manufacturing cost of the cathode ray tube.

### SUMMARY

In one aspect, a cathode ray tube comprises a panel, a funnel fused to a rear end of the panel, an electron gun inserted into the funnel, the electron gun including a focus electrode for focusing electron beams emitted from a cathode, and a field controller positioned inside or on a surface of the focus electrode, the field controller surrounding a portion or the entire of an outside electron beam among the aligned electron beams.

The field controller may be made of a magnetic material.

The focus electrode may include a first focus electrode and a second focus electrode. The field controller may be attached to a surface of the first focus electrode, and the surface of the first focus electrode may be adjacent to the second focus electrode.

The focus electrode may include a first focus electrode and a second focus electrode. The field controller may be attached to a surface of the second focus electrode, and the surface of the second focus electrode may be adjacent to the first focus electrode.

The outside electron beam may include a blue electron beam and a red electron beam. The cathode ray tube may further comprise a vertical deflection coil generating a vertical deflection magnetic field, wherein a distance between an end portion of the vertical deflection coil and the field controller may lie substantially in a range between 30 mm and 45 mm.

In another aspect, an electron gun comprises a control electrode that controls electron beams emitted from a cathode, an acceleration electrode that accelerates the electron beams, and a focus electrode that focuses the electron beams, a field controller that surrounds a portion or the entire of an outside electron beam among the aligned electron beams being positioned inside or on a surface of the focus electrode.

The field controller may be made of a magnetic material.

The focus electrode may include a first focus electrode and a second focus electrode. The field controller may be attached to a surface of the first focus electrode, and the surface of the first focus electrode may be adjacent to the second focus electrode.

The focus electrode may include a first focus electrode and a second focus electrode. The field controller may be attached to a surface of the second focus electrode, and the surface of the second focus electrode may be adjacent to the first focus electrode.

The outside electron beam may include a blue electron beam and a red electron beam.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 shows an electron beam affected by a vertical deflection magnetic field;

FIG. 2 shows a CY coil used to improve vertical convergence characteristics;

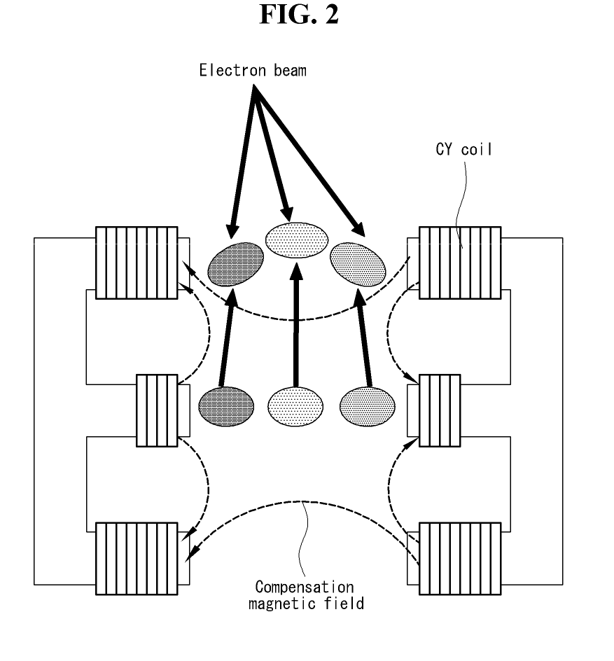

FIG. 3 shows a cathode ray tube according to an exemplary embodiment;

FIGS. 4 and 5 illustrate a first implementation of an electron gun included in the cathode ray tube of FIG. 3;

FIG. 6 illustrates a second implementation of the electron gun;

FIG. 7 illustrates a third implementation of the electron gun;

FIG. 8 shows a distance between an end portion of a vertical deflection coil of a deflection yoke and a field controller;

FIG. 9 shows spot characteristics on the screen in case that a field controller is attached to a shield cup; and

FIG. 10 shows vertical convergence characteristics in case that a field controller is attached to a focus electrode in the same way as the first to third implementations.

### DETAILED DESCRIPTION OF EMBODIMENTS

Reference will now be made in detail embodiments of the invention examples of which are illustrated in the accompanying drawings.

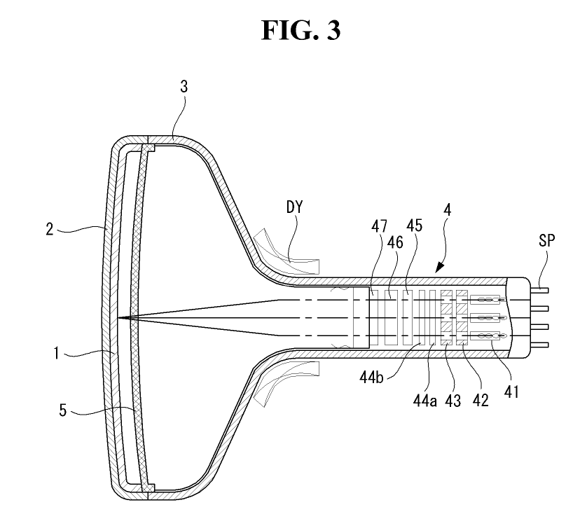

FIG. 3 shows a cathode ray tube according to an exemplary embodiment. As shown in FIG. 3, the cathode ray tube according to the exemplary embodiment includes a panel 2, a funnel 3 fused to a rear end of the panel 2, an electron gun 4 inserted into a neck part of the funnel 3 to emit an electron beam, a deflection yoke DY for deflecting the electron beam emitted from the electron gun 4, and a shadow mask 5 mounted inside the panel 2. The shadow mask 5 has a plurality of holes positioned at a regular interval to allow the electron beam to pass through the plurality of holes. The panel 2 is coated with phosphors 1 emitting red, green, and blue light, respectively, and explosion proof means are fixed to a front surface of the panel 2.

A heater mounted inside a cathode 41 of the electron gun 4 receives a power from a stem pin and emits electrons. The emitted electrons pass through the shadow mask 5 and impinge the phosphors 1. Hence, the phosphors 1 produce light, and thus an image is displayed.

The emitted electrons is controlled by a control electrode 42 and accelerated by an acceleration electrode 43. An electron beam formed by the electrons is partially focused and accelerated by a third electrode 44a, a fourth electrode 44b, and a first focus electrode 45. A second focus electrode 46 and an anode electrode 47 focus and accelerate the electron beam in earnest to form a main lens. While the cathode ray tube according to the exemplary embodiment includes the first focus electrode 45 and the second focus electrode 46, the cathode ray tube according to the exemplary embodiment may use one focus electrode to focus the electron beam.

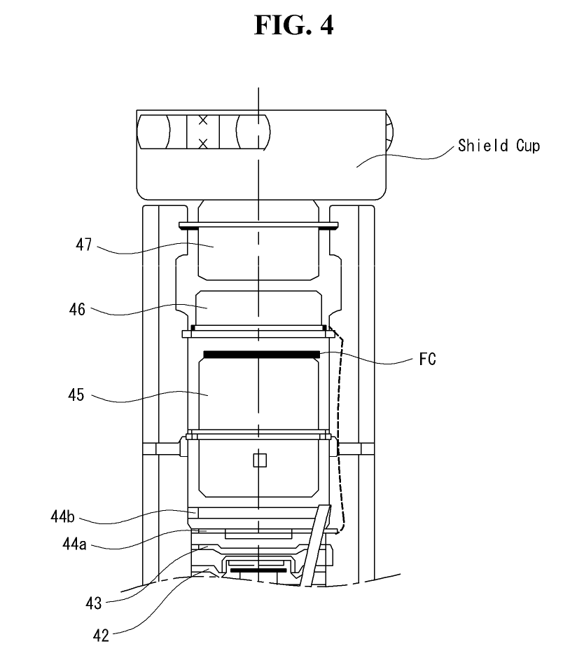

FIGS. 4 and 5 illustrate a first implementation of the electron gun. More specifically, FIG. 4 is a lateral view of the electron gun, and FIG. 5 is a front view a field controller FC installed in the electron gun. As shown in FIGS. 4 and 5, the electron gun according to the first implementation includes the field controller FC. The field controller FC is attached to a surface of the first focus electrode 45, and the surface of the first focus electrode 45 is adjacent to the second focus electrode 46. The second focus electrode 46 is positioned between the first focus electrode 45 and the anode electrode 47.

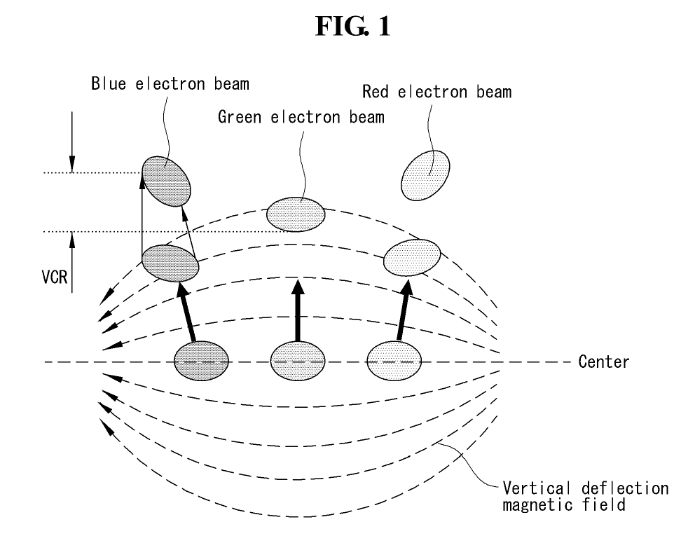

As shown in FIG. 5, the field controller FC is made of a magnetic material. The field controller FC surrounds a portion or the entire of two outside electron beams BB and RB among the three aligned electron beams BB, GB, and RB, and does not surround the central electron beam GB. The electron beams BB, GB, and RB indicate a blue electron beam, a green electron beam, and a red electron beam, respectively. A disposition of the electron beams may change. As above, because the field controller FC surrounds the portion or the entire of the outside electron beams BB and RB, a compensation magnetic field produced by the field controller FC is formed along the field controller FC. Then, the compensation magnetic field is formed toward the central electron beam GB around the central electron beam GB not surrounded by the field controller FC. The compensation magnetic field toward the central electron beam GB and a magnetic field shield against the outside electron beams BB and RB compensate for a barrel-shaped vertical deflection magnetic field (refer to FIG. 1), and thus vertical convergence characteristics are improved. In other words, because the compensation magnetic field produced by the field controller FC is formed in a direction capable of offsetting a central portion of the barrel-shaped vertical deflection magnetic field, the vertical convergence characteristics are improved.

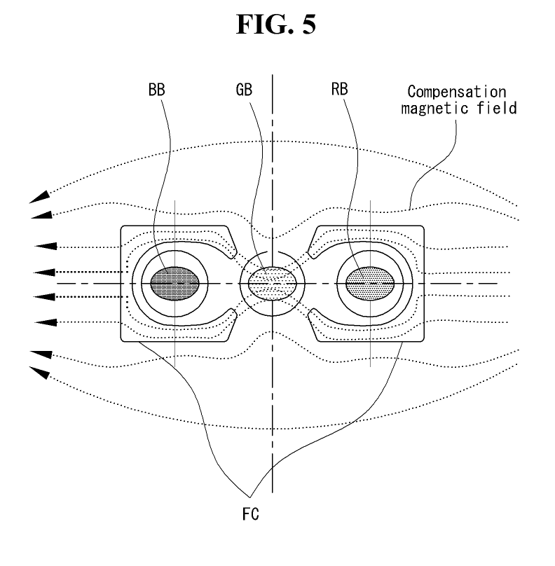

FIG. 6 illustrates a second implementation of the electron gun. The electron gun according to the second implementation includes the first focus electrode 45 and the second focus electrode 46, and a field controller FC is attached to a surface of the second focus electrode 46. The surface of the second focus electrode 46 is adjacent to the first focus electrode 45. The field controller FC of FIG. 6 is made of a magnetic material. Since a shape and a function of the field controller FC shown in FIG. 6 are the same as the field controller FC shown in FIG. 5, a description thereof is omitted.

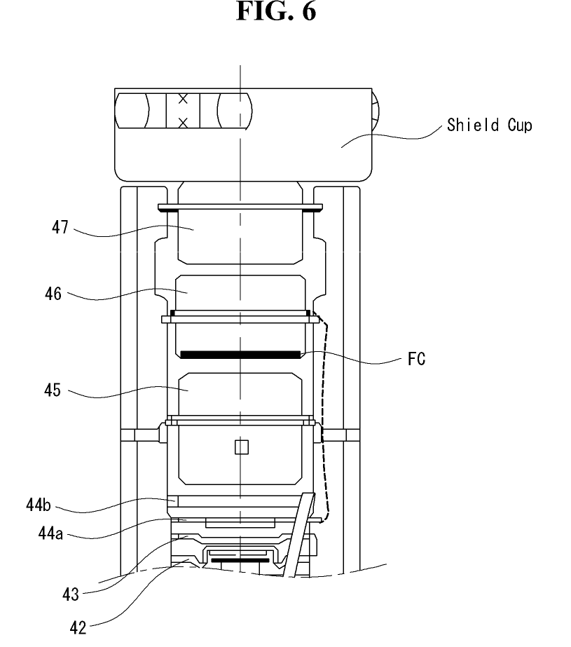

FIG. 7 illustrates a third implementation of the electron gun. The electron gun according to the third implementation includes a focus electrode 45′ having the structure in which the first focus electrode 45 and the second focus electrode 46 of the first or second implementation are combined with each other. The electron gun according to the third implementation includes a field controller FC positioned inside the focus electrode 45′. Since a shape and a function of the field controller FC shown in FIG. 7 are the same as the field controller FC shown in FIG. 5, a description thereof is omitted.

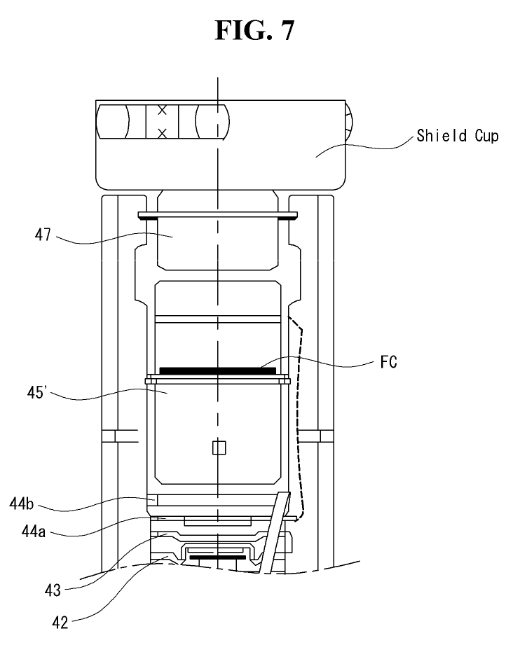

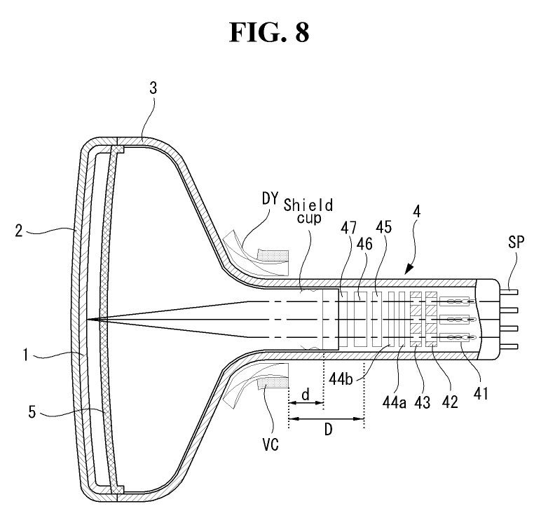

As shown in FIG. 8, in case that the field controller is attached to a shied cup, a distance d between an end portion of a vertical deflection coil VC generating a vertical deflection magnetic field of the deflection yoke DY and the field controller is very short. Hence, a magnetic field difference between the central electron beam GB and the outside electron beams RB and BB greatly increases. Accordingly, as shown in FIG. 9, because spot characteristics of the red and blue electron beams in 10-o'clock and 2-o'clock directions of the screen are worse than spot characteristics of red and blue electron beams of a related art cathode ray tube including a CY coil in 10-o'clock and 2-o'clock directions of the screen, a focus around the screen is degraded.

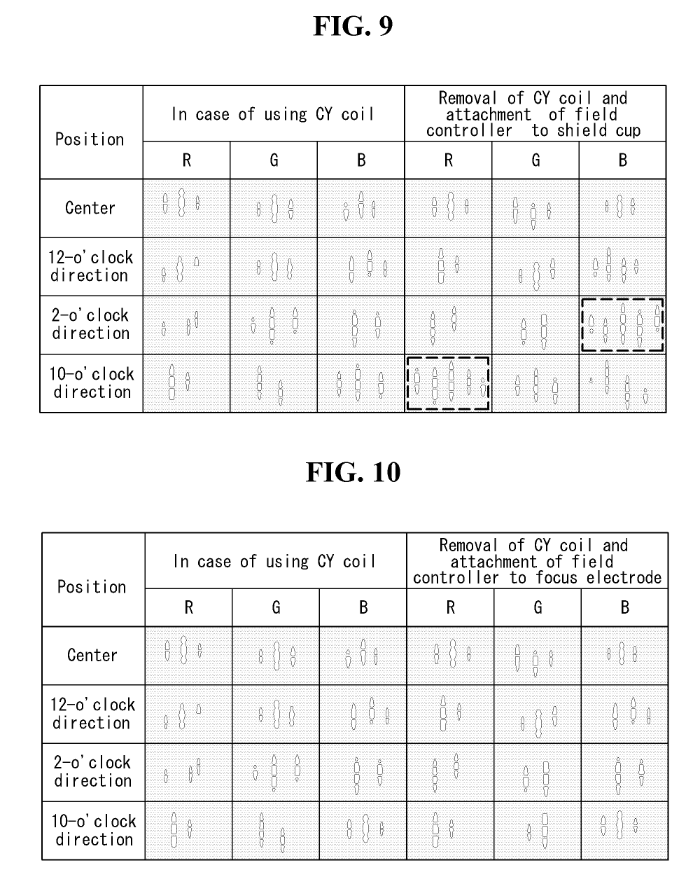

FIG. 10 shows vertical convergence characteristics in case that a field controller is attached to a focus electrode in the same way as the first to third implementations. As shown in FIG. 10, in case that the field controller is attached to the focus electrode of the electron gun according to the exemplary embodiment, a distance D between the end portion of the vertical deflection coil VC generating the vertical deflection magnetic field of the deflection yoke DY and the field controller, as shown in FIG. 8, increases. Hence, it can be seen from FIG. 10 that the vertical convergence characteristics of the red and blue electron beams in the 10-o'clock and 2-o'clock directions are almost similar to vertical convergence characteristics of the red and blue electron beams of the related art cathode ray tube including the CY coil in the 10-o'clock and 2-o'clock directions.

The distance D between the end portion of the vertical deflection coil VC generating the vertical deflection magnetic field of the deflection yoke DY and the field controller may lie substantially in a range between 30 mm and 45 mm. In case that the distance D is equal to or shorter than 30 mm, as shown in FIG. 9, the spot characteristics worsen. In case that the distance D is equal to or longer than 45 mm, a magnetic field shielding effect of the outside electron beams against the vertical deflection magnetic field is lowered, and thus problems in the vertical convergence characteristics occurs.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A cathode ray tube comprising:
a panel;
a funnel fused to a rear end of the panel;
an electron gun inserted into the funnel, the electron gun including a focus electrode for focusing electron beams emitted from a cathode; and
a field controller positioned inside or on a surface of the focus electrode, the field controller surrounding a portion or the entire of an outside electron beam among the aligned electron beams.

2. The cathode ray tube of claim 1, wherein the field controller is made of a magnetic material.

3. The cathode ray tube of claim 1, wherein the focus electrode includes a first focus electrode and a second focus electrode, and
the field controller is attached to a surface of the first focus electrode, and the surface of the first focus electrode is adjacent to the second focus electrode.

4. The cathode ray tube of claim 1, wherein the focus electrode includes a first focus electrode and a second focus electrode, and
the field controller is attached to a surface of the second focus electrode, and the surface of the second focus electrode is adjacent to the first focus electrode.

5. The cathode ray tube of claim 1, wherein the outside electron beam includes a blue electron beam and a red electron beam.

6. The cathode ray tube of claim 1, further comprising a vertical deflection coil generating a vertical deflection magnetic field,
wherein a distance between an end portion of the vertical deflection coil and the field controller lies substantially in a range between 30 mm and 45 mm.

7. An electron gun comprising:
a control electrode that controls electron beams emitted from a cathode;
an acceleration electrode that accelerates the electron beams; and
a focus electrode that focuses the electron beams, a field controller that surrounds a portion or the entire of an outside electron beam among the aligned electron beams being positioned inside or on a surface of the focus electrode.

8. The electron gun of claim 7, wherein the field controller is made of a magnetic material.

9. The electron gun of claim 7, wherein the focus electrode includes a first focus electrode and a second focus electrode, and
the field controller is attached to a surface of the first focus electrode, and the surface of the first focus electrode is adjacent to the second focus electrode.

10. The electron gun of claim 7, wherein the focus electrode includes a first focus electrode and a second focus electrode, and
the field controller is attached to a surface of the second focus electrode, and the surface of the second focus electrode is adjacent to the first focus electrode.

11. The electron gun of claim 7, wherein the outside electron beam includes a blue electron beam and a red electron beam.
